(19) United States
(12) Patent Application Publication
(10) Pub. No.: US 2013/0241421 A1
(43) Pub. Date: Sep. 19, 2013

(54) LED HYBRID POWER

(71) Applicant: LUMINYS SYSTEMS CORP., North Hollywood, CA (US)

(72) Inventor: David Pringle, North Hollywood, CA (US)

(73) Assignee: Luminys Systems Corp., North Hollywood, CA (US)

(21) Appl. No.: 13/794,001

(22) Filed: Mar. 11, 2013

Related U.S. Application Data
(60) Provisional application No. 61/610,444, filed on Mar. 13, 2012.

(51) Int. Cl. H05B 37/02

(52) U.S. Cl. CPC H05B 37/02
USPC 315/171; 315/172

(57) ABSTRACT

A hybrid power supply for a high intensity light includes a power supply coupled to the high intensity light, wherein the power supply has a power rating less than a power rating for the high intensity light, and a battery, the battery having a power rating greater than or equal to the power rating for the high intensity light. A switch is coupled between the high intensity light and the battery, such that when the switch is closed the battery is coupled to the high intensity light, and such that when the switch is open the battery is not coupled to the high intensity light.

### CROSS REFERENCE TO RELATED APPLICATIONS

The present application is related to and claims priority to U.S. Provisional Patent Application Ser. No. 61/610,444 filed on Mar. 13, 2012, which is hereby incorporated by reference in its entirety.

### TECHNICAL FIELD

This disclosure relates to power for high intensity lighting, and in particular to power for high power LEDs and arrays of LEDs.

### BACKGROUND

Powering high intensity lighting requires that high power be provided, which may require high power electric circuits. In the prior art, the power source used is typically the building's alternating current (AC) power source. However, this approach requires that the building's AC power be rated at the full capacity and power load rating of the high intensity lighting, which may be expensive to install and maintain. This expense is also wasteful, because the full capacity power load rating may be needed only for brief periods.

For example, some lighting applications such as high speed image capture with film or video cameras require only a low light level during the set up phase of the process. During the set up phase, a low light level is sufficient to make sure the light is pointed in the correct direction. Then high intensity lighting is only needed for a brief period during the actual high speed event, such as filming or high speed image capture of a bullet firing or a car crashing.

If the high intensity lighting is powered continually at high power during setup, a cooling system, which may be expensive, must be provided to cool the high intensity lighting. If the building power source is instead used to supply bursts of high power during only the brief period of image capture, then the building power may experience large power surges, which unless properly accounted for can impact other parties in the building. This is particularly significant in instances where the high intensity lighting employs large arrays of light emitting diodes (LEDs). Such large arrays of LEDs achieve extremely high light levels, but consume large amounts of power.

What is needed is a way to power high intensity lighting, while avoiding the cost of installing and maintaining a building's power source at the full capacity load rating. Also needed is a way to reduce the cost of cooling for high intensity lighting and to avoid power surges on a building's power source. The embodiments of the present disclosure answer these and other needs.

### SUMMARY

In an embodiment disclosed herein, a hybrid power supply for a high intensity light comprises a power supply coupled to the high intensity light, wherein the power supply has a power rating less than a power rating for the high intensity light, a battery, the battery having a power rating greater than or equal to the power rating for the high intensity light, and a switch coupled between the high intensity light and the battery, such that when the switch is closed the battery is coupled to the high intensity light, and such that when the switch is open the battery is not coupled to the high intensity light.

In another embodiment disclosed herein, a method of providing power for a high intensity light comprises providing a power supply coupled to the high intensity light, wherein the power supply has a power rating less than a power rating for the high intensity light, providing a battery, the battery having a power rating greater than or equal to the power rating for the high intensity light, and providing a switch coupled between the high intensity light and the battery, such that when the switch is closed the battery is coupled to the high intensity light, and such that when the switch is open the battery is not coupled to the high intensity light.

These and other features and advantages will become further apparent from the detailed description and accompanying figures that follow. In the figures and description, numerals indicate the various features, like numerals referring to like features throughout both the drawings and the description.

### BRIEF DESCRIPTION OF THE DRAWINGS

FIG. 1 shows a hybrid power source for high intensity lighting in accordance with the present disclosure;

FIG. 2 shows a LED array in accordance with the present disclosure; and

FIG. 3 shows LED array mounted on different heat sinks in accordance with the present disclosure;

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

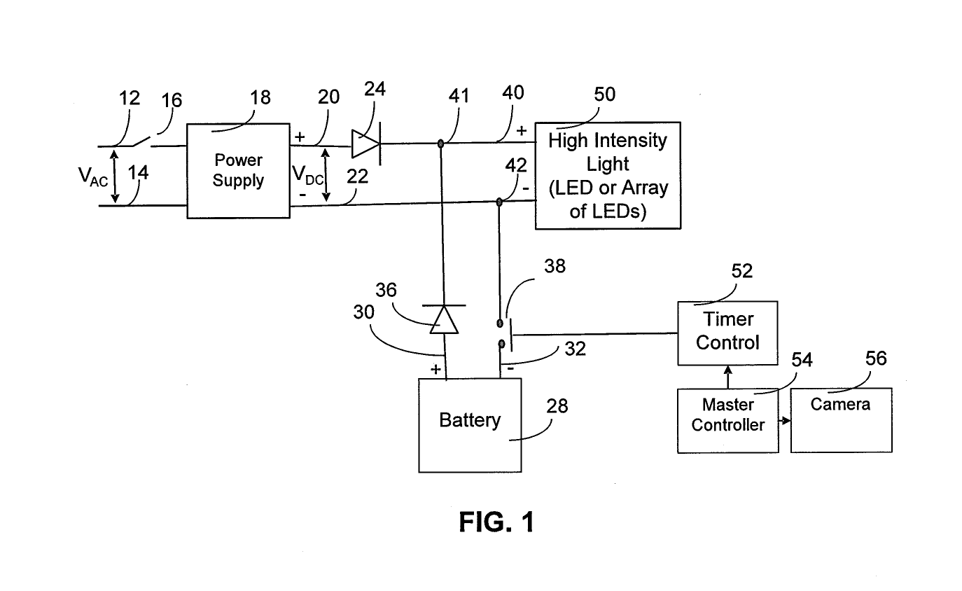

Referring now to FIG. 1, a hybrid power source is shown for high intensity lighting in accordance with the present disclosure. A power source 12, 14, which may be an alternating current (AC) power source, is connected to a power supply 18, which may be an alternating current (AC) to direct current (DC) converter. The connection of the power source 12, 14 to the power supply 18 may be switched on and off with switch 16. The switch 16 may be part of the power supply 18 or be a separate from the power supply 18.

The power source 12, 14 may preferably be a single phase 110 to 120 volt alternating current power source at 60 Hz, which is the conventional household power in the United States. The power source may also be any other power form, such as the power form used in Europe, which differs from the United States standard. The European standard is 220-240 volts at 50 Hz.

The power supply 18 converts the power from the power source 12, 14 to a direct current (DC) voltage across terminals 20 and 22 with a relatively low DC current capacity. In the case where the power source 12, 14 is an alternating current (AC) power source, the power supply 18 converts the AC to direct current (DC). The power supply 18 has a power rating that is less than a full power rating for a high intensity light 50. For example, the power supply 18 may have a power rating that ranges from as little as 1 percent or less of a full power rating for a high intensity light 50. Or, the power supply may have a power rating of 20 percent to as much as 50 percent of the full power rating for the high intensity light 50. A low power rating of the power supply 18 is sufficient during a set up phase, for example, to make sure the light is pointed in the correct direction.

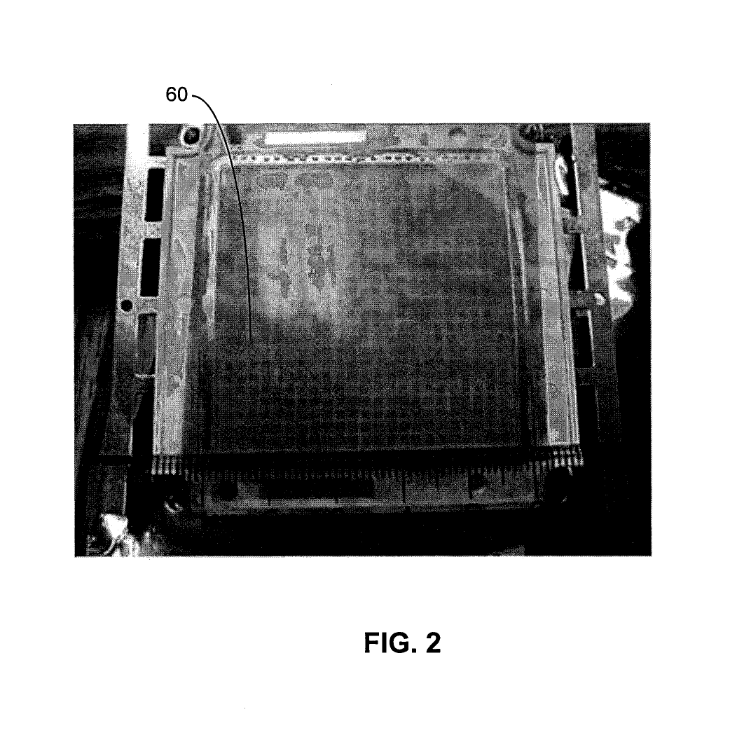

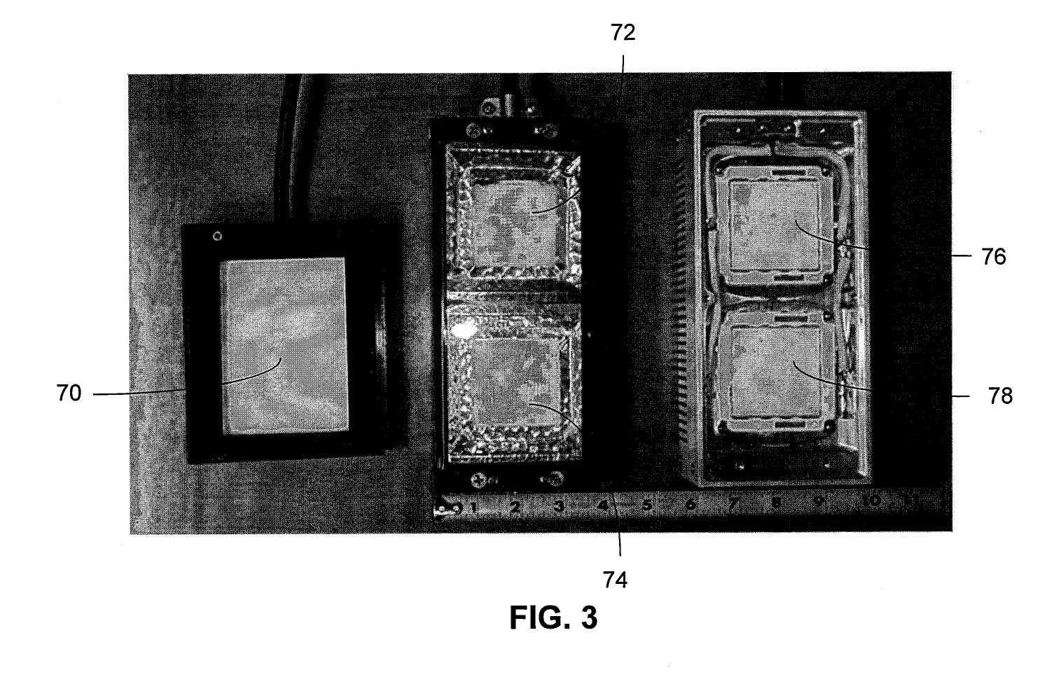

The high intensity light may be an LED 50 or an array of LEDs 50. Arrays of LEDs are especially useful for high intensity lighting and the arrays may be various sizes and various power rating. FIGS. 2 and 3 show various arrays of LEDs. FIG. 2 shows a 600 watt un-mounted LED array 60. FIG. 3 shows a 1200 watt LED array 70 mounted on heat sink, two 600 watt LED arrays 72 and 74 mounted on one type of heat sync, and two 600 watt LED arrays 76 and 78 mounted on another type of heat sink. The LED 50 shown in FIG. 1 may be various sizes of LED arrays, such as a 600 watt or 1200 watt array, or may be multiple LED arrays.

The number of LEDs in any array may range from 1 LED to many LEDs arranged in various configurations. For example, an array of LEDs may have 40 rows of 28 LEDs in series for a total of 1120 LEDs, or 20 rows of 28 LEDs in series for a total of 560 LEDs. A high intensity light 50 may have multiple arrays of LEDs, for example 150 LED arrays each rated at 1120 watts. Such a high intensity light can be extremely bright. Each LED may nominally be approximately a 1 W LED and produce about 100 to 140 lumens of light. Each LED may require about 3.1V or more for full intensity. When rows of LEDs are in series, the voltage required for full power is the number of LEDs in series times the voltage required, for example, 28 times 3.1 volts, or about 87 volts, and the current required may be 9 to 18 amperes. The LEDs may also be operated at a higher voltage to achieve higher intensity; however, the LED may operate less efficiently. For example, it is possible to drive a 1,200 watt LED array to levels up to 2,400 watts for brief periods using a higher battery voltage and more current.

In one unlimiting example, the power from the power supply 18 is such that an LED array 50, with a power rating of about 1200 watts, may be run at only a low intensity light level of one percent of less than the full power rating for the LED array. For example, the DC voltage across terminals 20 and 22 at the output of the power supply 18 may be 72 volts at 0.1 amperes DC, for a power of only 7.2 watts, which is less than 1 percent of the 1200 watt rating. This is not enough to power the LED array for high intensity lighting, but is sufficient for low level light, which is useful for preparing for a high speed image capture session.

As shown in FIG. 1, the power supply 18 terminals 20 and 22 are connected to terminals 40 and 42 of LED 50, respectively. As discussed above, the high intensity light 50 may be an LED, an array of LEDs, and may also be any other high intensity lighting. A battery 28 with terminals 30 and 32 is also connected to terminals 40 and 42 of LED 50. A switch 38 is between one of the terminal 30 or 32 and the respective terminal 40 or 42 on the LED 50. When the switch is closed or On the battery 28 supplies high power to the LED 50. When the switch is open or Off the battery 28 is disconnected from the LED 50. Switch 38 may be a relay. Switch 38 is shown as between terminal 32 on the battery 28 and terminal 42 on the LED 50. A person skilled in the art would understand that the switch 38 may instead be placed between terminal 30 on the battery 28 and terminal 41.

The LED may be run continuously at a very low “idle level” using only the power from power supply 18, as described above, and then boosted to full power or somewhat above full power for a brief period for high intensity lighting. High power is achieved by switching switch 38 closed to connect the battery 28 to the LED 50. The battery 28 may be an array of batteries, and may be rechargeable. For an array of LEDs rated at about 1200 watts, the battery may be rated to provide 94 VDC @ 13 amps, with would deliver 1222 watts of power to LED 50. For high speed imaging this high level need only be held for approximately 2 to 40 seconds, however for some unique applications it could be held for a shorter or much longer as necessary. The actual event, such as a bullet firing or a car crash, may be as short as a second or a few seconds.

The switch 38 may be connected to a timer controller 52, which may in turn be connected to a master controller 54, which also controls a high speed camera 56. The master controller 54 and timer controller 52 ensures that the timing for the high intensity lighting and the high speed image capture are properly synchronized. The high speed light 50 is turned On before the camera is activated and turned Off after the image capture is complete.

To isolate the power supply 18 terminal 20 from the voltage output at battery terminal 30, diode 24 is provided. Similarly diode 36 isolates battery terminal 30 from the voltage output at terminal 20 of the power supply 18.

The combination of the AC to DC power supply 18 with the battery 28 according to the present disclosure provides a way to power high intensity lighting, while avoiding the cost of installing and maintaining a building's AC power at the full capacity power load rating of the high intensity light 50. Also avoided are power surges on a building's AC power. Another advantage is that the high intensity light 50 requires less cooling when operated for only a brief period at high power. High intensity lights generate lots of heat, but using high power for only a brief period reduces the heat dramatically and reduces the overall cost and weight, because the high intensity lighting can be operated with a lighter and less expensive cooling system.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . .”

What is claimed is:

1. A hybrid power supply for a high intensity light comprising:
a power supply coupled to the high intensity light, wherein the power supply has a power rating less than a power rating for the high intensity light;
a battery, the battery having a power rating greater than or equal to the power rating for the high intensity light; and
a switch coupled between the high intensity light and the battery, such that when the switch is closed the battery is coupled to the high intensity light, and such that when the switch is open the battery is not coupled to the high intensity light.

2. The hybrid power supply of claim 1 wherein:
the power supply is powered by an alternating current power source.

3. The hybrid power supply of claim 1 wherein:
the high intensity light comprises first and second high intensity light terminals;
the power supply comprises first and second power output terminals;
the battery comprises first and second battery terminals;
the first high intensity light terminal is coupled to the first power output terminal and to the first battery terminal;
the second high intensity light terminal is coupled to the second power output terminal and to the switch; and
the switch is coupled to the second battery terminal.

4. The hybrid power supply of claim 3 further comprising:
a first diode between the first battery terminal and the first high intensity light terminal; and
a second diode between the first power output terminal and the first high intensity light terminal.

5. The hybrid power supply of claim 1 wherein:
the high intensity light comprises first and second high intensity light terminals;
the power supply comprises first and second power output terminals;
the battery comprises first and second battery terminals;
the first high intensity light terminal is coupled to the first power output terminal and to the switch;
the second high intensity light terminal is coupled to the second power output terminal and to the battery; and
the switch is coupled to the first battery terminal.

6. The hybrid power supply of claim 5 further comprising:
a first diode between the first battery terminal and the first high intensity light terminal; and
a second diode between the first power output terminal and the first high intensity light terminal.

7. The hybrid power supply of claim 1 wherein the high intensity light comprises a light emitting diode.

8. The hybrid power supply of claim 1 wherein the high intensity light comprises an array of light emitting diodes.

9. The hybrid power supply of claim 1 wherein:
the high intensity light has a power rating of 1100 to 1200 watts;
the power supply has a power rating of about 72 volts at 0.1 amperes DC; and
the battery has a power rating of about 94 volts at 13 amps DC.

10. The hybrid power supply of claim 1 further comprising:
a timer controller coupled to the switch for controlling opening or closing the switch.

11. The hybrid power supply of claim 10 further comprising:
a master controller coupled to the timer controller; and
a high speed camera coupled to the master controller;
wherein the master controller controls timing for operating the timer controller and the camera.

12. The hybrid power supply of claim 11 wherein:
the master controller controls the timer controller to close the switch for 2 to 40 seconds and then opens the switch.

13. The hybrid power supply of claim 12 wherein:
the master controller controls the timer controller to turn on the camera for a period of time during which the switch is closed.

14. The hybrid power supply of claim 1 wherein the power supply comprises an alternating current to direct current power supply.

15. The hybrid power supply of claim 1 wherein the battery is a rechargeable battery.

16. The hybrid power supply of claim 1 wherein the power supply has a power rating of 1 percent or less of the power rating for the high intensity light.

17. The hybrid power supply of claim 1 wherein the power supply has a power rating of 50 percent or less of the power rating for the high intensity light.

18. A method of providing power for a high intensity light comprising:
providing a power supply coupled to the high intensity light, wherein the power supply has a power rating less than a power rating for the high intensity light;
providing a battery, the battery having a power rating greater than or equal to the power rating for the high intensity light; and
providing a switch coupled between the high intensity light and the battery, such that when the switch is closed the battery is coupled to the high intensity light, and such that when the switch is open the battery is not coupled to the high intensity light.

19. The method of claim 18 wherein the high intensity light comprises a light emitting diode, or an array of light emitting diodes.

20. The method of claim 18 wherein the power supply comprises an alternating current to direct current power supply.

21. The method of claim 18 further comprising closing the switch for a brief period for capture a high speed image of an event.

22. The method of claim 18 wherein the power supply has a power rating of 1 percent or less of the power rating for the high intensity light.

23. The method of claim 18 wherein the power supply has a power rating of 50 percent or less of the power rating for the high intensity light.
